(19) United States
(12) Patent Application Publication
(10) Pub. No.: US 2007/0281598 A1
(43) Pub. Date: Dec. 6, 2007

(54) Ventilating hood for water heater

(75) Inventors: Hsin-Ming Huang, Taichung City (TW); Kuan-Chou Lin, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: GRAND MATE CO., LTD., Taichung City (TW)

(21) Appl. No.: 11/444,259

(22) Filed: May 31, 2006

(51) Int. Cl. B08B 15/02

(52) U.S. Cl. 454/56

(57) ABSTRACT

A ventilating hood for a water heater includes a housing having an inside formed with an air chamber, a substantially V-shaped guide board mounted in the air chamber of the housing and located between two opposite sides of the housing, and two movable boards each pivotally mounted on a respective one of the two opposite sides of the housing and each facing the guide board. Thus, the waste gas is drained outwardly from the air outlet ports of the housing smoothly and exactly by guidance of the guide board and the movable boards, thereby enhancing the air circulation in the air chamber of the housing, and thereby enhancing the working efficiency of the water heater.

### BACKGROUND OF THE INVENTION

1. Field of the Invention

The present invention relates to a ventilating hood and, more particularly, to a ventilating hood for a water heater.

2. Description of the Related Art

A conventional ventilating hood for a water heater comprises a housing having an inside formed with an air chamber, and a burner mounted in the air chamber of the housing. The air chamber of the housing has a top provided with an air outlet hole and a bottom provided with an air inlet hole. A drain pipe is connected to the air outlet hole of the housing to drain waste gas produced by the burner outwardly from the air outlet hole of the housing. Thus, the ambient air flows from the air inlet hole into the air chamber of the housing and the waste gas contained in the air chamber of the housing is carried toward outwardly from the air outlet hole. However, when the ambient pressure at the air outlet hole is greater than that of the air chamber of the housing due to a larger wind, the ambient air flows from the air outlet hole into the air chamber of the housing, so that the waste gas cannot be drained from the air outlet hole.

### BRIEF SUMMARY OF THE INVENTION

In accordance with the present invention, there is provided a ventilating hood, comprising a housing having an inside formed with an air chamber, a substantially V-shaped guide board mounted in the air chamber of the housing and located between two opposite sides of the housing, and two movable boards each pivotally mounted on a respective one of the two opposite sides of the housing and each facing the guide board.

The primary objective of the present invention is to provide a ventilating hood, wherein the waste gas is drained outwardly from the air outlet ports of the housing smoothly and exactly by guidance of the guide board and the movable boards, thereby enhancing the air circulation in the air chamber of the housing, and thereby enhancing the working efficiency of the water heater.

Another objective of the present invention is to provide a ventilating hood, wherein the rising waste gas is accelerated to flow toward the guide board and the respective movable board by guidance of the spoilers of the housing so that the waste gas is drained outwardly from the air outlet ports of the housing rapidly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a ventilating hood in accordance with the preferred embodiment of the present invention.

FIG. 2 is an exploded perspective view of the ventilating hood as shown in FIG. 1.

FIG. 3 is a side plan view of the ventilating hood as shown in FIG. 1.

FIG. 4 is a front plan cross-sectional view of the ventilating hood as shown in FIG. 1.

FIG. 5 is a schematic operational view of the ventilating hood as shown in FIG. 4.

FIG. 6 is a front plan cross-sectional view of a ventilating hood in accordance with another preferred embodiment of the present invention.

### DETAILED DESCRIPTION OF THE INVENTION

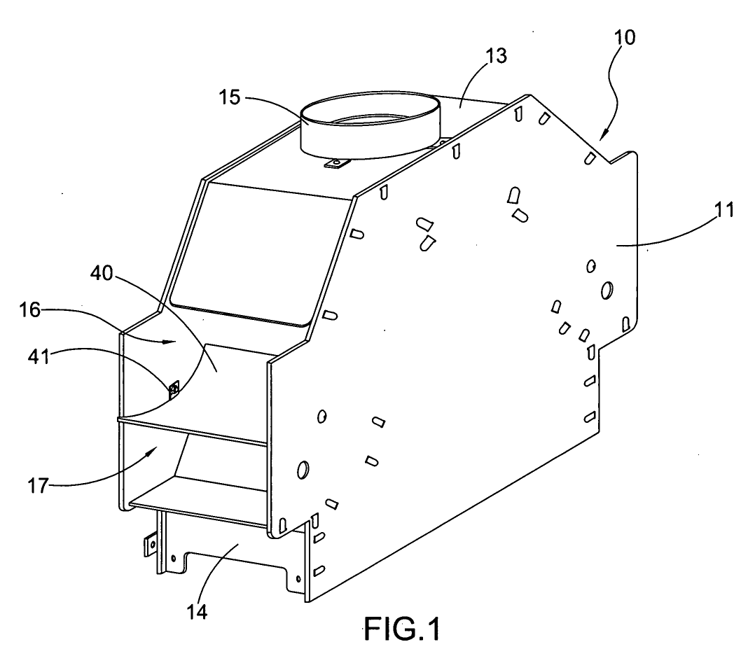

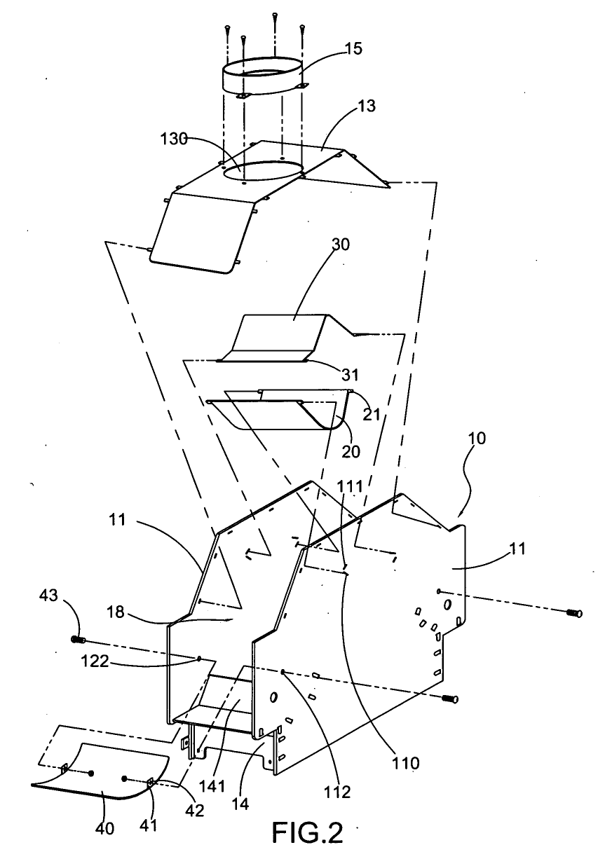

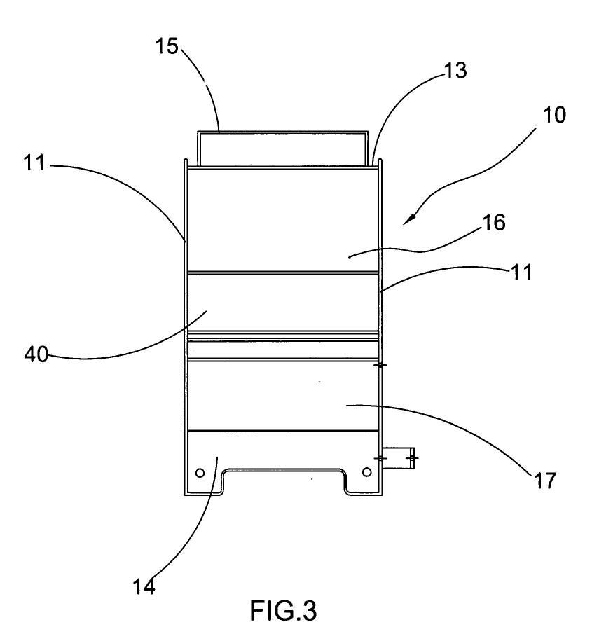

Referring to the drawings and initially to FIGS. 1-4, a ventilating hood for a water heater in accordance with the preferred embodiment of the present invention comprises a housing 10 having an inside formed with an air chamber 18, a substantially V-shaped guide board 20 mounted in the air chamber 18 of the housing 10 and located between two opposite sides of the housing 10, a substantially inverted V-shaped secondary guide board 30 mounted in the air chamber 18 of the housing 10 and located above the guide board 20, and two movable boards 40 each pivotally mounted on a respective one of the two opposite sides of the housing 10 and each facing the guide board 20.

The air chamber 18 of the housing 10 has a top provided with an air outlet hole 130 and a bottom provided with a burner 19 and an air inlet hole 140, and the guide board 20 is located between the air outlet hole 130 and the burner 19 to separate the air outlet hole 130 from the burner 19 and the air inlet hole 140.

The housing 10 includes two symmetrically arranged support plates 11, a top cover 13 mounted between upper portions of the support plates 11, and a bottom cover 14 mounted between lower portions of the support plates 11. Each of the support plates 11 of the housing 10 has a plurality of mounting holes 110, a plurality of slots 111, and a plurality of pivot holes 112.

Thus, the air chamber 18 of the housing 10 is defined by the support plates 11, the top cover 13 and the bottom cover 14 to receive the burner 19, water pipes (not shown), igniter (not shown), an electronic control board (not shown), a heat exchanger (not shown) and the like.

The air outlet hole 130 of the housing 10 is formed in the top cover 13, and the air inlet hole 140 of the housing 10 is formed in the bottom cover 14, so that the ambient air flows from the air inlet hole 140 into the air chamber 18 of the housing 10 and the waste gas (produced by the burner 19) contained in the air chamber 18 of the housing 10 is drained outwardly from the air outlet hole 130. A pipe connector 15 is mounted on the air outlet hole 130 of the housing 10 to connect a drain pipe (not shown) to drain the waste gas.

The guide board 20 has a plurality of snapping plates 21 snapped into the mounting holes 110 of each of the support plates 11 so that the guide board 20 is located between the support plates 11 of the housing 10.

The secondary guide board 30 has two opposite ends aligning with two opposite ends of the guide board 20 and has a plurality of snapping plates 31 snapped into the slots 111 of each of the support plates 11 so that the secondary guide board 30 is located between the support plates 11 of the housing 10.

Each of the movable boards 40 is pivotally mounted between the support plates 11 of the housing 10 and located between the top cover 13 and the bottom cover 14. Each of the movable boards 40 is substantially arc-shaped and has two opposite pivot ears 41 each having a pivot bore 42 pivotally connected to the respective pivot hole 112 of each of the support plates 11 by a fastening unit 43.

Each of the two opposite sides of the housing 10 is divided by the respective movable board 40 into an air outlet port 16 located above the respective movable board 40 and located between the air outlet hole 130 and the respective movable board 40, and an air inlet port 17 located under the respective movable board 40 and located between the air inlet hole 140 and the respective movable board 40. Thus, the ambient air flows from the air inlet hole 140 and the air inlet port 17 into the air chamber 18 of the housing 10 and the waste gas contained in the air chamber 18 of the housing 10 is drained outwardly from the air outlet hole 130.

The bottom cover 14 of the housing 10 has two opposite sides provided with two upward extending oblique spoilers 141 each directed toward the guide board 20 and the respective movable board 40 to introduce the wasted gas toward the guide board 20 and the respective movable board 40.

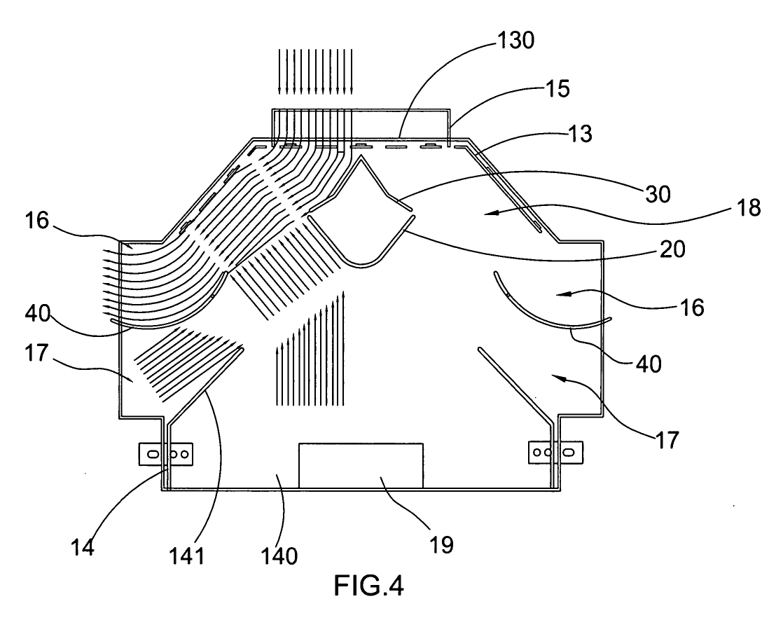

As shown in FIG. 4, the ambient air flows from the air inlet hole 140 and the air inlet port 17 into the air chamber 18 of the housing 10 and the waste gas contained in the air chamber 18 of the housing 10 is carried toward outwardly from the air outlet hole 130. At this time, when the ambient pressure at the air outlet hole 130 is greater than that of the air chamber 18 of the housing 10, the ambient air flows from the air outlet hole 130 into the air chamber 18 of the housing 10, so that the waste gas cannot be drained from the air outlet hole 130.

In such a manner, the rising waste gas contained in the air chamber 18 of the housing 10 is guided by the guide board 20, and the dropping ambient air from the air outlet hole 130 is guided by the secondary guide board 30, so that the rising waste gas and the dropping ambient air are mixed and drained outwardly from the air outlet ports 16 of the housing 10 by guidance of the movable boards 40, thereby enhancing the air circulation in the air chamber 18 of the housing 10, and thereby enhancing the working efficiency of the water heater.

At the same time, the rising waste gas is accelerated to flow toward the guide board 20 and the respective movable board 40 by guidance of the spoilers 141 of the housing 10 so that the waste gas is drained outwardly from the air outlet ports 16 of the housing 10 rapidly.

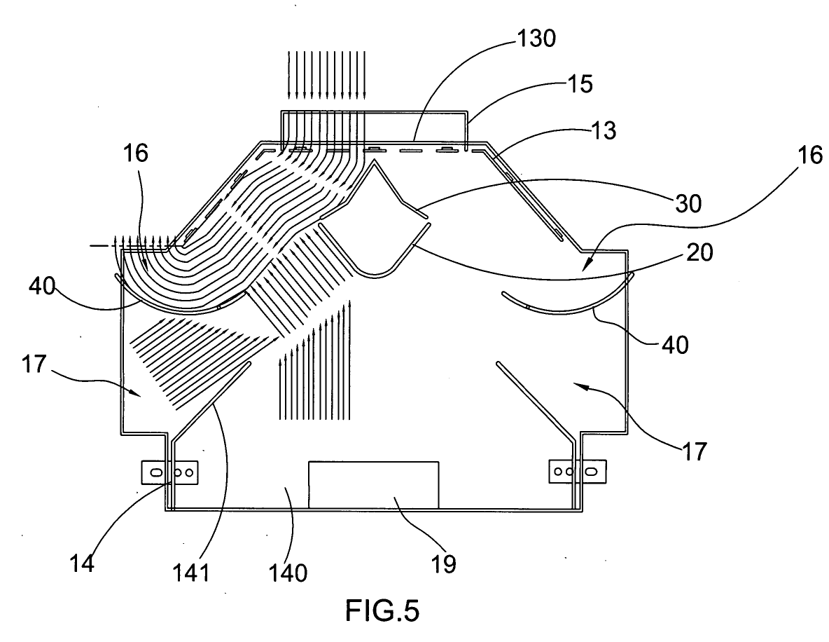

As shown in FIG. 5, the angle between each of the movable boards 40 and the guide board 20 (or the secondary guide board 30) is adjustable by pivoting each of the movable boards 40 to adjust the angle of the waste gas from the air outlet ports 16 of the housing 10 rapidly.

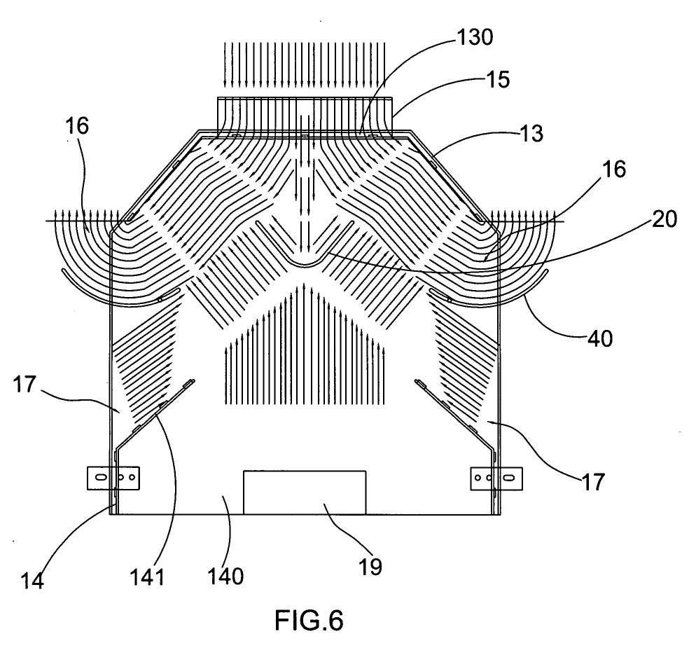

As shown in FIG. 6, the secondary guide board 30 is undefined.

Accordingly, the waste gas is drained outwardly from the air outlet ports 16 of the housing 10 smoothly and exactly by guidance of the guide board 20 and the movable boards 40, thereby enhancing the air circulation in the air chamber 18 of the housing 10, and thereby enhancing the working efficiency of the water heater. In addition, the rising waste gas is accelerated to flow toward the guide board 20 and the respective movable board 40 by guidance of the spoilers 141 of the housing 10 so that the waste gas is drained outwardly from the air outlet ports 16 of the housing 10 rapidly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A ventilating hood, comprising:
a housing having an inside formed with an air chamber;
a substantially V-shaped guide board mounted in the air chamber of the housing and located between two opposite sides of the housing;
two movable boards each pivotally mounted on a respective one of the two opposite sides of the housing and each facing the guide board.

2. The ventilating hood in accordance with claim 1, wherein the air chamber of the housing has a top provided with an air outlet hole and a bottom provided with a burner and an air inlet hole, and the guide board is located between the air outlet hole and the burner to separate the air outlet hole from the burner and the air inlet hole.

3. The ventilating hood in accordance with claim 2, wherein the housing includes two symmetrically arranged support plates, a top cover mounted between upper portions of the support plates, and a bottom cover mounted between lower portions of the support plates.

4. The ventilating hood in accordance with claim 3, wherein the air chamber of the housing is defined by the support plates, the top cover and the bottom cover to receive the burner.

5. The ventilating hood in accordance with claim 3, wherein the air outlet hole of the housing is formed in the top cover.

6. The ventilating hood in accordance with claim 3, wherein the air inlet hole of the housing is formed in the bottom cover.

7. The ventilating hood in accordance with claim 1, further comprising a pipe connector mounted on the air outlet hole of the housing.

8. The ventilating hood in accordance with claim 3, wherein each of the support plates of the housing has a plurality of mounting holes, and the guide board has a plurality of snapping plates snapped into the mounting holes of each of the support plates so that the guide board is located between the support plates of the housing.

9. The ventilating hood in accordance with claim 3, wherein each of the movable boards is pivotally mounted between the support plates of the housing and located between the top cover and the bottom cover.

10. The ventilating hood in accordance with claim 1, wherein each of the movable boards is substantially arc-shaped.

11. The ventilating hood in accordance with claim 3, wherein each of the support plates of the housing has a plurality of pivot holes, and each of the movable boards has two opposite pivot ears each having a pivot bore pivotally connected to the respective pivot hole of each of the support plates by a fastening unit.

12. The ventilating hood in accordance with claim 1, wherein each of the two opposite sides of the housing is divided by the respective movable board into an air outlet port located above the respective movable board and located between the air outlet hole and the respective movable board, and an air inlet port located under the respective movable board and located between the air inlet hole and the respective movable board.

13. The ventilating hood in accordance with claim 3, wherein the bottom cover of the housing has two opposite sides provided with two upward extending oblique spoilers each directed toward the guide board and the respective movable board.

14. The ventilating hood in accordance with claim 1, wherein an angle between each of the movable boards and the guide board is adjustable by pivoting each of the movable boards.

15. The ventilating hood in accordance with claim 3, further comprising a substantially inverted V-shaped secondary guide board mounted in the air chamber of the housing and located above the guide board.

16. The ventilating hood in accordance with claim 15, wherein the secondary guide board has two opposite ends aligning with two opposite ends of the guide board.

17. The ventilating hood in accordance with claim 15, wherein each of the support plates of the housing has a plurality of slots, and the secondary guide board has a plurality of snapping plates snapped into the slots of each of the support plates so that the secondary guide board is located between the support plates of the housing.
